(19) United States
(12) Patent Application Publication
(10) Pub. No.: US 2011/0302214 A1
(43) Pub. Date: Dec. 8, 2011

(54) METHOD FOR UPDATING A DATABASE

(75) Inventors: Mark S. Frye, Grosse Pointe Woods, MI (US); Steven C. Tengler, Grosse Pointe Park, MI (US)

(73) Assignee: GENERAL MOTORS LLC, Detroit, MI (US)

(21) Appl. No.: 12/793,669

(22) Filed: Jun. 3, 2010

(51) Int. Cl. G06F 17/30

(52) U.S. Cl. 707/802; 707/E17.005

(57) ABSTRACT

A method for updating a database involves determining, via a processor operatively associated with a vehicle, a location circle within which the vehicle is then-currently located, and obtaining, from a facility, a database corresponding to the location circle. The method further involves detecting, via a sensor selectively and operatively disposed in the vehicle, a stationary object along a road segment that is located in the location circle, and determining, via a processor associated with the vehicle, that the detected stationary object is missing from the database. Upon making such determination, a communications device disposed in the vehicle transmits an image of the stationary object to the facility. A processor at the facility then updated the database corresponding to the location circle within which the vehicle is then-currently located with information related to the detected stationary object.

### TECHNICAL FIELD

The present disclosure relates generally to methods for updating a database.

### BACKGROUND

Information pertaining to various roadside objects are often compiled and stored in a database at a local authority, municipal data center, or the like. The database may include information such as a type of object (e.g., a street sign, a street lamp, a bench at a bus stop, a trash barrel, etc.) and a then-current location of the object (measured, e.g., by GPS coordinate data). Updating the database may, in some instances, be a time consuming process, such as when the updating is accomplished manually. Manual updating of the database may include, for example, dispatching a vehicle whose driver manually records the type and location of each object that he/she sees while traveling along a road segment.

### SUMMARY

A method for updating a database involves determining, via a processor operatively associated with a vehicle, a location circle within which the vehicle is then-currently located, and obtaining, from a facility, a database corresponding to the location circle. The method further involves detecting, via a sensor selectively and operatively disposed in the vehicle, a stationary object along a road segment that is located in the location circle, and determining, via a processor associated with the vehicle, that the detected stationary object is missing from the database. Upon making such determination, a communications device disposed in the vehicle transmits an image of the stationary object to the facility. A processor at the facility then updates the database corresponding to the location circle within which the vehicle is then-currently located with information related to the detected stationary object.

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic diagram depicting an example of a system for updating a database;

FIG. 2 is a flow diagram depicting an example of a method for updating a database;

FIG. 3 is a flow diagram depicting another example of the method for updating a database; and

FIG. 4 is a schematic diagram illustrating the example depicted in FIG. 3.

### DETAILED DESCRIPTION

Example(s) of the method disclosed herein may be used to update a database containing information pertaining to various stationary, roadside objects. The database updating method utilizes subscriber vehicles to obtain and catalog information about the objects each time the vehicle travels along a road segment. The information is ultimately used to update a central database at a telematics call or data center, as well as to provide up-to-date information of stationary, roadside objects to other entities such as, e.g., municipalities, geographic information systems and/or companies (e.g., NAVTEQ®, Tele Atlas®, etc.), and/or the like.

It is to be understood that, as used herein, the term “user” includes a vehicle owner, operator, and/or passenger, and such term may be used interchangeably with the term subscriber/service subscriber.

Also as used herein, a “stationary object” refers to any object that is located along a road segment, and is configured to remain stationary (i.e., the object is not intended to move). It is to be understood that stationary objects, although intended to remain stationary, may move under certain circumstances, for example, during a weather incident (for instance, as a result of high winds, floods, etc. where the object is dislodged from its original position and moved to another or is bent), when struck by a vehicle (e.g., as a result of an accident), when intentionally moved (or in some cases removed) by one or more persons, and/or the like. Some non-limiting examples of stationary objects include street signs (e.g., stop signs, speed limit signs, hazard signs (e.g., deer crossing, railroad crossing, etc.), informational signs, historical and/or landmark signs, emergency related signs, etc.), construction objects (e.g., construction signs, construction barrels, sand bags, etc.), bus stop related objects (e.g., bus stop signs and covered and non-covered benches), landmarks (e.g., clock towers, rock formations, etc.), public waste disposal objects (e.g., trash barrels), fire hydrants, electronic traffic signals, electrical poles and/or wires, telephone poles and/or wires, parking meters, post office boxes, street lamps, tolling booths, vehicle crash barriers, and/or the like, and/or combinations thereof.

Furthermore, a stationary object located “along a road segment” refers to an object that is located on the road segment (e.g., directly on the pavement, the dirt, or other material defining the road), next to the road segment (e.g., on a curb, a sidewalk, a shoulder, a patch of grass planted next to the road, etc.), in the road segment (e.g., a sewer, a light reflector, etc.), or above the road segment (e.g., a traffic light).

Additionally, the terms “connect/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in operative communication with the other component (notwithstanding the presence of one or more additional components therebetween).

Also, the term “communication” is to be construed to include all forms of communication, including direct and indirect communication. As such, indirect communication may include communication between two components with additional component(s) located therebetween.

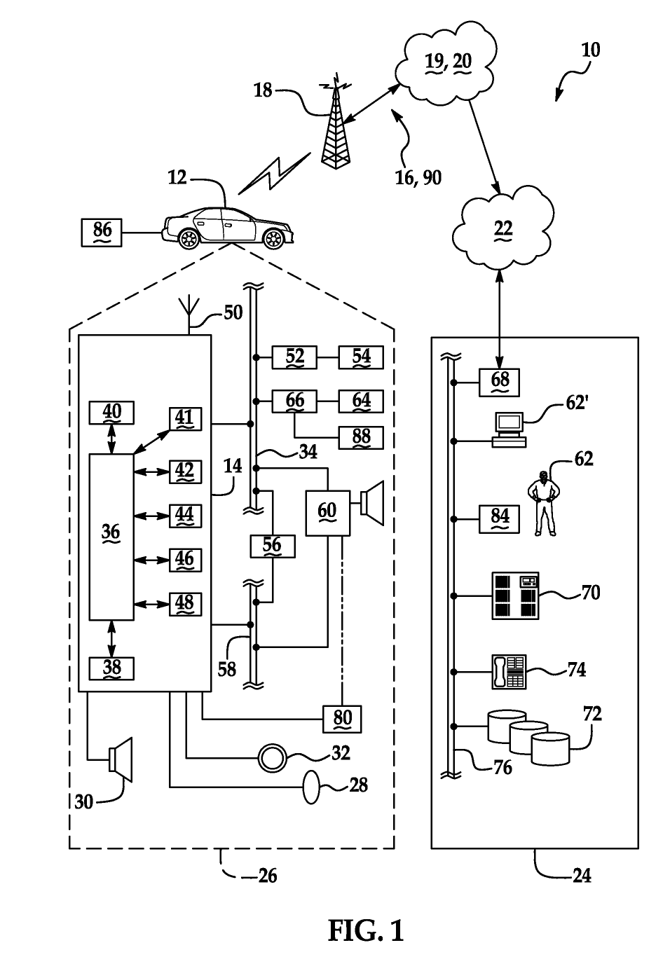

FIG. 1 described in detail below depicts a system (identified by reference character 10) for updating a database using a telematics unit 14 disposed in a vehicle 12. It is to be understood that the system 10 depicted in FIG. 1 is provided herein for purposes of illustrating one example of a system with which the example methods disclosed herein may be accomplished. The examples of the method may also be used to update a database via other systems. For instance, an application executable by a processor resident on a portable communications device (e.g., a smart phone, a personal digital assistant (PDA), a tablet, or the like), and this application is configured to communicate with a call/data center 24. The portable communications device may be used in a mobile vehicle (such as the vehicle 12 shown in FIG. 1) or outside of a vehicle, and may also be configured to provide services according to a subscription agreement with a third party facility (e.g., the call/data center 24 shown in FIG. 1).

Referring now to FIG. 1, one non-limiting example of a system 10 for updating a database includes a vehicle 12, a telematics unit 14, a carrier/communication system 16 (including, but not limited to, one or more cell towers 18, one or more base stations 19 and/or mobile switching centers (MSCs) 20, and one or more service providers (not shown)), one or more land networks 22, and one or more telematics service call/data centers 24. In an example, the carrier/communication system 16 is a two-way radio frequency communication system.

The overall architecture, setup and operation, as well as many of the individual components of the system 10 shown in FIG. 1 are generally known in the art. Thus, the following paragraphs provide a brief overview of one example of such a system 10. It is to be understood, however, that additional components and/or other systems not shown here could employ the method(s) disclosed herein.

Vehicle 12 is a mobile vehicle such as a motorcycle, car, truck, recreational vehicle (RV), boat, plane, etc., and is equipped with suitable hardware and software that enables it to communicate (e.g., transmit and/or receive voice and data communications) over the carrier/communication system 16.

Some of the vehicle hardware 26 is shown generally in FIG. 1, including the telematics unit 14 and other components that are operatively connected to the telematics unit 14. Examples of such other hardware 26 components include a microphone 28, a speaker 30 and buttons, knobs, switches, keyboards, and/or controls 32. Generally, these hardware 26 components enable a user to communicate with the telematics unit 14 and any other system 10 components in communication with the telematics unit 14. It is to be understood that the vehicle 12 may also include additional components suitable for use in, or in connection with, the telematics unit 14.

Operatively coupled to the telematics unit 14 is a network connection or vehicle bus 34. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name a few. The vehicle bus 34 enables the vehicle 12 to send and receive signals from the telematics unit 14 to various units of equipment and systems both outside the vehicle 12 and within the vehicle 12 to perform various functions, such as unlocking a door, executing personal comfort settings, and/or the like.

The telematics unit 14 is an onboard vehicle dedicated communications device that provides a variety of services, both individually and through its communication with the call/data center 24. The call/data center 24 includes at least one facility that is owned and operated by the telematics service provider. The telematics unit 14 generally includes an electronic processing device 36 operatively coupled to one or more types of electronic memory 38, a cellular chipset/component 40, a vehicle data upload (VDU) unit 41, a wireless modem 42, a navigation unit containing a location detection (e.g., global positioning system (GPS)) chipset/component 44, a real-time clock (RTC) 46, a short-range wireless communication network 48 (e.g., a BLUETOOTH® unit), and/or a dual antenna 50. In one example, the wireless modem 42 includes a computer program and/or set of software routines executing within processing device 36.

It is to be understood that the telematics unit 14 may be implemented without one or more of the above listed components, such as, for example, the short-range wireless communication network 48. It is to be further understood that telematics unit 14 may also include additional components and functionality as desired for a particular end use.

The electronic processing device 36 may be a micro controller, a controller, a microprocessor, a host processor, and/or a vehicle communications processor. In another example, electronic processing device 36 may be an application specific integrated circuit (ASIC). Alternatively, electronic processing device 36 may be a processor working in conjunction with a central processing unit (CPU) performing the function of a general-purpose processor. In a non-limiting example, the electronic processing device 36 (also referred to herein as a processor) includes software programs having computer readable code to initiate and/or perform one or more steps of the methods disclosed herein. For instance, the software programs may include computer readable code for determining whether or not a detected stationary object is missing from a database stored in the electronic memory 38.

The location detection chipset/component 44 may include a Global Position System (GPS) receiver, a radio triangulation system, a dead reckoning position system, and/or combinations thereof. In particular, a GPS receiver provides accurate time and latitude and longitude coordinates of the vehicle 12 responsive to a GPS broadcast signal received from a GPS satellite constellation (not shown).

The cellular chipset/component 40 may be an analog, digital, dual-mode, dual-band, multi-mode and/or multi-band cellular phone. The cellular chipset-component 40 uses one or more prescribed frequencies in the 800 MHz analog band or in the 800 MHz, 900 MHz, 1900 MHz and higher digital cellular bands. Any suitable protocol may be used, including digital transmission technologies such as TDMA (time division multiple access), CDMA (code division multiple access) and GSM (global system for mobile telecommunications). In some instances, the protocol may be short-range wireless communication technologies, such as BLUETOOTH®, dedicated short-range communications (DSRC), or Wi-Fi.

Also associated with electronic processing device 36 is the previously mentioned real time clock (RTC) 46, which provides accurate date and time information to the telematics unit 14 hardware and software components that may require and/or request such date and time information. In an example, the RTC 46 may provide date and time information periodically, such as, for example, every ten milliseconds.

The telematics unit 14 provides numerous services alone or in conjunction with the call/data center 24, some of which may not be listed herein, and is configured to fulfill one or more user or subscriber requests. Several examples of such services include, but are not limited to: turn-by-turn directions and other navigation-related services provided in conjunction with the GPS based chipset/component 44; airbag deployment notification and other emergency or roadside assistance-related services provided in connection with various crash and or collision sensor interface modules 52 and sensors 54 located throughout the vehicle 12; and infotainment-related services where music, Web pages, movies, television programs, videogames and/or other content is downloaded by an infotainment center 56 operatively connected to the telematics unit 14 via vehicle bus 34 and audio bus 58. In one non-limiting example, downloaded content is stored (e.g., in memory 38) for current or later playback.

Again, the above-listed services are by no means an exhaustive list of all the capabilities of telematics unit 14, but are simply an illustration of some of the services that the telematics unit 14 is capable of offering. It is to be understood that when such services are obtained from the call/data center 24, the telematics unit 14 is considered to be operating in a telematics service mode.

Vehicle communications generally utilize radio transmissions to establish a voice channel with carrier system 16 such that both voice and data transmissions may be sent and received over the voice channel. Vehicle communications are enabled via the cellular chipset/component 40 for voice communications and the wireless modem 42 for data transmission. In order to enable successful data transmission over the voice channel, wireless modem 42 applies some type of encoding or modulation to convert the digital data so that it can communicate through a vocoder or speech codec incorporated in the cellular chipset/component 40. It is to be understood that any suitable encoding or modulation technique that provides an acceptable data rate and bit error may be used with the examples disclosed herein. Generally, dual mode antenna 50 services the location detection chipset/component 44 and the cellular chipset/component 40.

Transmission of data pertaining to the detected stationary object (e.g., images, location data, etc.) to the call/data center 24 may take place over the voice channel. The vehicle hardware 26 includes a vehicle data upload VDU unit/system 41 that transmits data during a voice connection in the form of packet data over a packet-switch network (e.g., voice over Internet Protocol (VoIP), communication system 16, etc.). The telematics unit 14 may include the vehicle data upload (VDU) system 41 (as shown in FIG. 1), or the telematics unit 14 may be interfaced to the VDU system 41. In either configuration, the VDU system 41 is configured to receive raw sensor data (e.g., from stationary object detection sensor(s) 88) and/or an image (e.g., from an imaging device 86), packetize the data, and upload the packetized data message to the call/data center 24. In one example, the VDU 41 is operatively connected to the processor 36 of the telematics unit 14, and thus is in communication with the call/data center 24 via the bus 34 and the communication system 16. In another example, the VDU 41 may be the telematics unit's central data system that can include its own modem, processor, and on-board database. The database can be implemented using a separate network attached storage (NAS) device or be located elsewhere, such as in memory 38, as desired. The VDU 41 has an application program that handles all of the vehicle data upload processing, including communication with the call/data center 24, and the setting and processing of triggers (i.e., preset indicators of when sensor data, images, etc. are to be collected and/or uploaded).

The microphone 28 provides the user with a means for inputting verbal or other auditory commands, and can be equipped with an embedded voice processing unit utilizing human/machine interface (HMI) technology known in the art. Conversely, speaker 30 provides verbal output to the vehicle occupants and can be either a stand-alone speaker specifically dedicated for use with the telematics unit 14 or can be part of a vehicle audio component 60. In either event and as previously mentioned, microphone 28 and speaker 30 enable vehicle hardware 26 and telematics service data/call center 24 to communicate with the occupants through audible speech. The vehicle hardware 26 also includes one or more buttons, knobs, switches, keyboards, and/or controls 32 for enabling a vehicle occupant to activate or engage one or more of the vehicle hardware components. For instance, one of the buttons 32 may be an electronic pushbutton used to initiate voice communication with the telematics service provider data/call center 24 (whether it be a live advisor 62 or an automated call response system 62′), e.g., to request emergency services. The pushbutton 32 may otherwise be used to notify the data/call center 24 (upon visual inspection) that one or more stationary objects has/have been removed, damaged, or the like. Upon activating the pushbutton 32, the processor 36 may automatically request an image from the imaging device 86, or additional information from the user who activated the pushbutton 32. The additional information may, e.g., be recorded and stored in the memory 38 or automatically pushed to the data/call center 24 in addition to the image taken.

The audio component 60 is operatively connected to the vehicle bus 34 and the audio bus 58. The audio component 60 receives analog information, rendering it as sound, via the audio bus 58. Digital information is received via the vehicle bus 34. The audio component 60 provides AM and FM radio, satellite radio, CD, DVD, multimedia and other like functionality independent of the infotainment center 56. Audio component 60 may contain a speaker system, or may utilize speaker 30 via arbitration on vehicle bus 34 and/or audio bus 58.

Still referring to FIG. 1, the vehicle crash and/or collision detection sensor interface 52 is/are operatively connected to the vehicle bus 34. The crash sensors 54 provide information to the telematics unit 14 via the crash and/or collision detection sensor interface 52 regarding the severity of a vehicle collision, such as the angle of impact and the amount of force sustained.

Other vehicle sensors 64, connected to various sensor interface modules 66, are operatively connected to the vehicle bus 34. Example vehicle sensors 64 include, but are not limited to, gyroscopes, accelerometers, magnetometers, emission detection and/or control sensors, environmental detection sensors, and/or the like. One or more of the sensors 64 enumerated above may be used to obtain vehicle data for use by the telematics unit 14 or the data/call center 24 (when transmitted thereto from the telematics unit 14) to determine the operation of the vehicle 12. Non-limiting example sensor interface modules 66 include powertrain control, climate control, body control, and/or the like. It is to be understood that some of the data received from the other vehicle sensors 64 may also trigger one or more of the methods disclosed herein. Such other data may include, for example, data indicating that an airbag has been deployed, data pertaining to a sudden deceleration (e.g., upon colliding with another object such as another vehicle), data indicting a sudden increase in pressure exerted on the brake pedal (e.g., upon braking suddenly when attempting to avoid a collision), data pertaining to a sudden decrease in tire pressure (e.g., a flat tire while traveling down a road segment), or the like.

The stationary object detection sensor(s) 88 is/are also connected to an appropriate sensor interface module 66, which again is connected to the vehicle bus 34. The sensor(s) 88 may be a single sensor or a plurality of sensors disposed throughout the vehicle 12, where such sensor(s) 88 is/are configured to detect the presence of a stationary object located along a road segment. In an example, the vehicle 12 may include one sensor 88 on the left/driver side of the vehicle that is configured to detect stationary objects along the left/drive side of the road segment, and another sensor 88 on the right/passenger side of the vehicle that is configured to detect stationary objects along the right/passenger side of the road segment. The sensor(s) 88 is/are generally configured to transmit a signal to the telematics unit 14 via the bus 34 indicating that an object along the road segment is present. In some cases, the sensor(s) 88 is/are also configured to transmit additional data pertaining to the detected object such as, e.g., a distance the object is relative to the vehicle 12, the reflectivity of the object, and/or the like. The distance may be used, e.g., by the processor 36 associated with the telematics unit 14 to approximate the location of the detected object, whereas the reflectivity of the object may be used to deduce whether or not the object has been damaged or possibly vandalized. As will be described in detail below, upon receiving a signal from the sensor(s) 88, the processor 36 associated with the telematics unit 14 instructs the imaging device 86 to take an image of the object, which is ultimately used to i) identify the object, ii) determine whether or not the object is included in a database of roadside stationary objects, and iii) update the database if the object is missing. As used herein, an “image” refers to a still image (e.g., a picture, photograph, or the like) and/or to an image in motion (e.g., a video, movie, or the like).

In one non-limiting example, the vehicle hardware 26 also includes a display 80, which may be operatively directly connected to or in communication with the telematics unit 14, or may be part of the audio component 60. Non-limiting examples of the display 80 include a VFD (Vacuum Fluorescent Display), an LED (Light Emitting Diode) display, a driver information center display, a radio display, an arbitrary text device, a heads-up display (HUD), an LCD (Liquid Crystal Diode) display, and/or the like.

The electronic memory 38 of the telematics unit 14 may be configured to store data associated with the various systems of the vehicle 12, vehicle operations, vehicle user preferences and/or personal information, and the like. The electronic memory 38 is further configured to store a database containing information pertaining to roadside stationary objects. In one example, the database stored in the memory 38 contains information pertaining to roadside objects located in a telematics service region defined by the call/data center 24. In another example, the database contains information pertaining to roadside objects located within a location circle defined by where the vehicle 12 is then-currently located. In the latter example, the database is actually a compilation of information pertaining to all of the known stationary objects that are then-currently present along each road segment within that location circle.

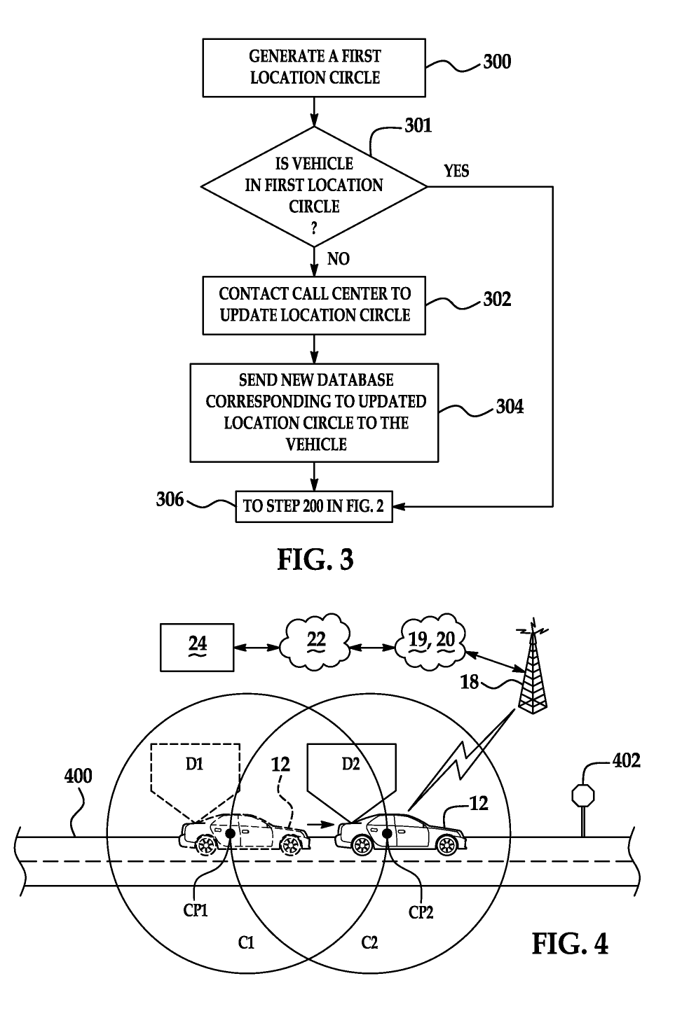

Furthermore, the database stored in the electronic memory 38 of the telematics unit 14 may be a subset of a central database stored at a facility. In an example, the facility is the telematics call/data center 24, and the central database includes all of the stationary objects that the call/data center 24 is aware of throughout the entire telematics service region. The central database may be broken down into smaller databases (or sub-databases), where at least one of these sub-databases is transmitted to the vehicle 12 and stored in the memory 38. For example, a sub-database covering a service region of the call/data center 24 within which the vehicle owner's garage address is located may be stored in the memory 38. In another example, a sub-database may be stored in the memory 38 that covers a preferred path to a known destination or multiple paths or corridors surrounding the preferred path, either of which may be determined directly from the user or from heuristics of previous travel by the user. In yet another example, a sub-database covering a location circle, which is determined at least from the then-current location of the vehicle 12 (determined, e.g., from GPS coordinate data), may be stored in the memory 38. In this latter example, the location circle that the vehicle 12 is then-currently located in may initially be determined by using, e.g., a garage address of the vehicle 12 owner as a center point, and then applying a predetermined radius (e.g., 30 miles, 100 miles, 200 miles, etc.) from the center point to complete the circle. As will be described in further detail below in conjunction with FIGS. 3 and 4, when the vehicle 12 travels outside of the initial location circle (e.g., Circle 1 depicted in FIG. 4), a new sub-database may be generated at the call/data center 24 for a new location circle of the vehicle 12. The new sub-database will have a new center point and thus will cover a different area than the initial circle. Therefore, the new sub-database will include information of the known stationary objects that are then-currently present along each road segment within the new location circle. This new sub-database is transmitted to the vehicle 12 and stored in the memory 38. As such, the sub-database stored in the vehicle 12 may be dynamically updated as the vehicle 12 travels. In some cases, the new sub-database replaces the previous one, while in other cases, the new sub-database is stored in addition to the previous database. In still other examples, the location circle with the user's garage address as the center point may be permanently stored memory 38 and any new location circles added while the vehicle 12 traveling may be temporarily stored until a new location circle is entered.

The central database stored at the call/data center 24 may also include sub-databases based on a classification of the stationary objects. For instance, one sub-database may be specifically designed for street signs (e.g., stop signs, yield signs, speed limit signs, etc.), while another sub-database may be specific for waste disposal objects (e.g., trash barrels, dumpsters, sewers, etc.), while yet another sub-database may be specific for to fire hydrants. In some cases, a single sub-database may include smaller sub-databases, e.g., the sub-database for street signs may include a sub-database for stops signs alone and another sub-database for yield signs alone. The sub-databases may be useful, for example, for updating a municipal database (i.e., a database from which other sources (e.g., geographic information systems and/or companies, the call/data center 24, or the like) obtain information of roadside objects throughout the city, state, region, country, etc.).

The sub-databases based on classification may be useful, for example, for more efficient dissemination of data to an appropriate entity (such as, e.g., a municipality). In some cases, the sub-databases based on classification may also facilitate transmission of the data to the entity. For example, the data may be transmitted in a staggered fashion based on the classification (e.g., street signs first, and then waste disposal objects, and then street lights, and so on). It is to be understood that, under some circumstances, one or more sub-databases may include more objects than other sub-databases (e.g., a sub-database for street signs may include significantly more objects than a sub-database for post office boxes in a given geographic region). The transmission of the sub-database based on a classification for post office boxes may thus occur more quickly/efficiently than the transmission of the sub-database for street signs. Yet further, the sub-databases based on classification may be useful in situations when a database needs to be updated regularly due, at least in part, to dynamic changes in the presence of or damage to a particular type of object. For instance, construction objects (e.g., construction signs, barrels, sand bags, etc.) may be present one day and then removed the next, and the sub-database containing construction objects may enable rapid refreshment of this type of data. Additionally, updating via sub-databases based on classification may, in some instances, reduce transmission costs (i.e., the cost to upload/download all of the information included in the central database each time the database is updated).

The creation of sub-databases may also enhance the efficiency of transmission of the sub-database to the vehicle 12. For example, one sub-database may be designated for storing objects with preset dimensions (e.g., stop signs, yield signs) where additional information (other than dimension information, GPS (latitude and longitude) information, and reflectivity information) is not required. This sub-database can be transmitted relatively quickly due to the amount of data contained therein. In other instances, sub-databases may be configured to require more information than simply the sub-database type, GPS information, and reflectivity information, such as, for example, height/length, width, QR code for sub-databases containing information about potholes, trash receptacles, quick response (QR) signs, etc.

The vehicle 12 further includes at least one imaging device 86 operatively disposed in or on vehicle 12. The imaging device(s) 86 is in operative and selective communication with the sensor(s) 88 that is/are configured to detect the stationary objects along the road segment upon which the vehicle 12 is then-currently traveling. The imaging device 86 is also in operative and selective communication with the processor 36, and is configured to take an image of a stationary objected detected by the sensor(s) 88 in response to a command by the processor 36. Communication between the imaging device 86 and the sensor(s) 88 and the processor 36 is accomplished, for example, via the bus 34 (described further hereinbelow).

In some instances, the vehicle 12 may include a single imaging device 86. In an example, the single imaging device 86 is a rotatable camera, such as a reverse parking aid camera, operatively disposed in or on the vehicle 12. In other instances, the vehicle 12 may include more than one imaging device 86. In these instances, the imaging devices 86 may include multiple cameras (that may be rotatable) disposed at predetermined positions in and/or on the vehicle 12.

A portion of the carrier/communication system 16 may be a cellular telephone system or any other suitable wireless system that transmits signals between the vehicle hardware 26 and land network 22. According to an example, the wireless portion of the carrier/communication system 16 includes one or more cell towers 18, base stations 19 and/or mobile switching centers (MSCs) 20, as well as any other networking components required to connect the wireless portion of the system 16 with land network 22. It is to be understood that various cell tower/base station/MSC arrangements are possible and could be used with the wireless portion of the system 16. For example, a base station 19 and a cell tower 18 may be co-located at the same site or they could be remotely located, and a single base station 19 may be coupled to various cell towers 18 or various base stations 19 could be coupled with a single MSC 20. A speech codec or vocoder may also be incorporated in one or more of the base stations 19, but depending on the particular architecture of the wireless network 16, it could be incorporated within an MSC 20 or some other network components as well.

Land network 22 may be a conventional land-based telecommunications network that is connected to one or more landline telephones and connects the wireless portion of the carrier/communication network 16 to the call/data center 24. For example, land network 22 may include a public switched telephone network (PSTN) and/or an Internet protocol (IP) network. It is to be understood that one or more segments of the land network 22 may be implemented in the form of a standard wired network, a fiber or other optical network, a cable network, other wireless networks such as wireless local networks (WLANs) or networks providing broadband wireless access (BWA), or any combination thereof.

The call/data center 24 of the telematics service provider is designed to provide the vehicle hardware 26 with a number of different system back-end functions. According to the example shown in FIG. 1, the call/data center 24 generally includes one or more switches 68, servers 70, databases 72, live and/or automated advisors 62, 62′, processing equipment (or processor) 84, as well as a variety of other telecommunication and computer equipment 74 that is known to those skilled in the art. These various telematics service provider components are coupled to one another via a network connection or bus 76, such as one similar to the vehicle bus 34 previously described in connection with the vehicle hardware 26.

One or more of the databases 72 at the data/call center 24 is/are configured to store the central database described above, as well as the sub-databases generated by the processor 84. The database(s) 72 is also configured to store other information related to various call/data center 24 processes, as well as information pertaining to the subscribers. In an example, the information pertaining to the subscribers may be stored as a profile, which may include, e.g., the subscriber's name, address, home phone number, cellular phone number, electronic mailing (e-mail) address, etc.). The profile may also include a history of stationary object detection and/or updates to the central database at the data/call center 24, the sub-databases downloaded to the memory 38, and the dates on which such downloads occurred. Details of generating the profile are described below.

The processor 84, which is often used in conjunction with the computer equipment 74, is generally equipped with suitable software and/or programs enabling the processor 84 to accomplish a variety of call/data center 24 functions. Such software and/or programs are further configured to perform one or more steps of the examples of the method disclosed herein. The various operations of the call/data center 24 are carried out by one or more computers (e.g., computer equipment 74) programmed to carry out some of the tasks of the method(s) disclosed herein. The computer equipment 74 (including computers) may include a network of servers (including server 70) coupled to both locally stored and remote databases (e.g., database 72) of any information processed.

Switch 68, which may be a private branch exchange (PBX) switch, routes incoming signals so that voice transmissions are usually sent to either the live advisor 62 or the automated response system 62′, and data transmissions are passed on to a modem or other piece of equipment (not shown) for demodulation and further signal processing. The modem preferably includes an encoder, as previously explained, and can be connected to various devices such as the server 70 and database 72.

It is to be appreciated that the call/data center 24 may be any central or remote facility, manned or unmanned, mobile or fixed, to or from which it is desirable to exchange voice and data communications. As such, the live advisor 62 may be physically present at the call/data center 24 or may be located remote from the call/data center 24 while communicating therethrough.

The communications network provider 90 generally owns and/or operates the carrier/communication system 16. In an example, the communications network provider 90 is a cellular/wireless service provider (such as, for example, VERIZON WIRELESS®, AT&T®, SPRINT®, etc.). It is to be understood that, although the communications network provider 90 may have back-end equipment, employees, etc. located at the telematics service provider data/call center 24, the telematics service provider is a separate and distinct entity from the network provider 90. In an example, the equipment, employees, etc. of the communications network provider 90 are located remote from the data/call center 24. The communications network provider 90 provides the user with telephone and/or Internet services, while the telematics service provider provides a variety of telematics-related services (such as, for example, those discussed hereinabove). It is to be understood that the communications network provider 90 may interact with the data/call center 24 to provide services to the user.

While not shown in FIG. 1, it is to be understood that in some instances, the telematics service provider operates the data center 24, which receives voice or data calls, analyzes the request associated with the voice or data call, and transfers the call to an application specific call center (not shown). It is to be understood that the application specific call center may include all of the components of the data center 24, but is a dedicated facility for addressing specific requests, needs, etc. Examples of such application specific call centers are emergency services call centers, navigation route call centers, in-vehicle function call centers, or the like.

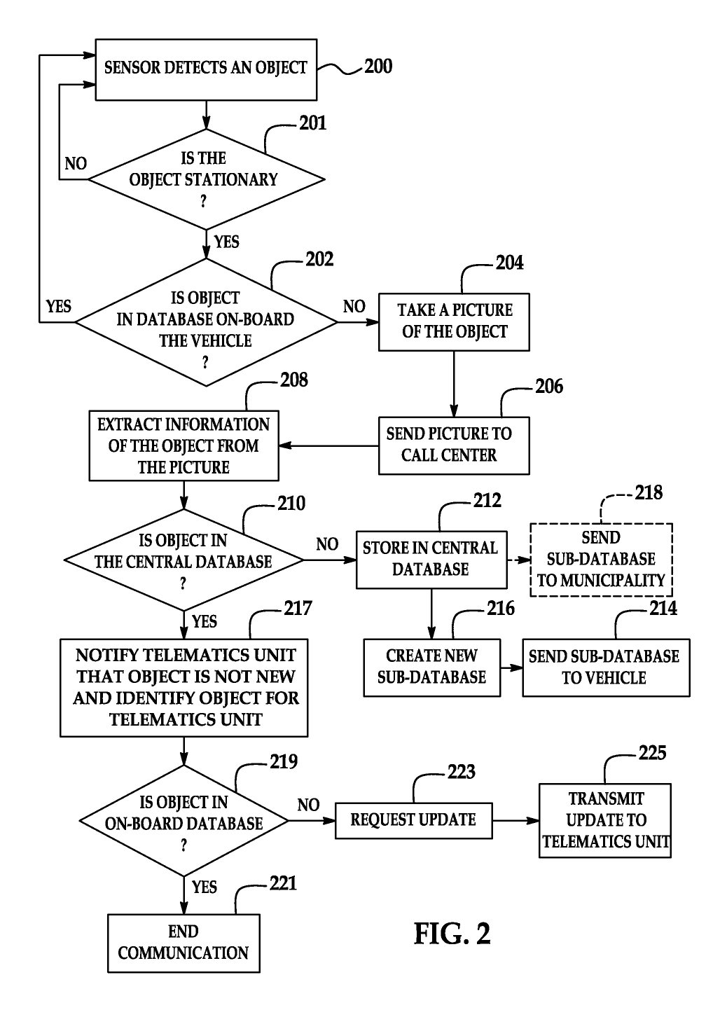

Examples of the method for updating a database will now be described in conjunction with FIGS. 2 through 4. More specifically, one example of the method will be described below in conjunction with FIG. 2 alone, while another example of the method will be described below in conjunction with FIGS. 2, 3, and 4 together. It is to be understood that any of these examples may be used to update a database, such as the sub-database stored on-board the vehicle 12 and the central database stored at the call/data center 24. In some instances, the examples may also be used to update a municipal database. As stated above, the sub-database, central database, and municipal database each include lists of roadside stationary objects (e.g., street signs, construction objects, etc.), where each list corresponds with a predefined geographic area. It is further to be understood that the updating of the database(s) is accomplished using subscriber vehicles (such as the vehicle 12) as probes for obtaining information pertaining to roadside stationary objects as the vehicles drive by such objects during their normal course of travel. Each of the subscriber vehicles 12 includes a respective telematics unit (such as the telematics unit 14) that is pre-configured to perform a service for detecting roadside objects, obtaining information pertaining to the detected roadside objects, and (in some cases) forwarding the information to a data repository (such as the data/call center 24).

In an example, each of the subscriber vehicles 12 is configured to perform the stationary object detecting service as soon as the owner of each respective vehicle 12 enters into a subscription agreement with the telematics service provider (i.e., the entity who/that owns and operates one or more of the call/data centers 24). In this example, all of the subscriber vehicles 12 are thus configured to perform the examples of the method disclosed herein.

In another example, a municipality or other authoritative entity may enter into a contract or some agreement with the telematics service provider to utilize one or more of its subscriber vehicles 12 to collect data (such as images, location data, and/or the like) of roadside stationary objects so that such data may ultimately be used to update a municipal database. Once this agreement is in place, the telematics service provider may ask the owners of its subscriber vehicles 12 for permission to use the vehicle 12 as a probe for collecting the roadside stationary object information. In instances where at least one subscriber vehicle 12 agrees to participate, the examples of the method may be accomplished so long as an account has been set up with the call/data center 24. As used herein, the term “account” refers to a representation of a business relationship established between the vehicle owner (or user) and the telematics service provider, where such business relationship enables the user to request and receive services from the call/data center 24 (and, in some instances, an application center (not shown)). The business relationship may be referred to as a subscription agreement/contract between the user and the owner of the call/data center 24, where such agreement generally includes, for example, the type of services that the user may receive, the cost for such services, the duration of the agreement (e.g., a one-year contract, etc.), and/or the like. In an example, the account may be set up by calling the call/data center 24 (e.g., by dialing a phone number for the call/data center 24 using the user's cellular, home, or other phone) and requesting (or selecting from a set of menu options) to speak with an advisor 62 to set up an account. In an example, the switch 68 at the call/data center 24 routes the call to an appropriate advisor 62, who will assist the user with opening and/or setting up the user's account. When the account has been set up, the details of the agreement established between the call/data center 24 owner (i.e., the telematics service provider) and the user, as well as personal information of the user (e.g., the user's name, garage address, home phone number, cellular phone number, electronic mailing (e-mail) address, etc.) are stored in a user profile in the database 72 at the call/data center 24. The user profile may be used by the telematics service provider, for example, when providing requested services or offering new services to the user.

In instances where the user elects to participate in the program for collecting stationary object information, the processor 84 at the call/data center 24 marks/flags the user's profile as a participating vehicle 12. The user may also select the length of time that he/she will participate in the program. It is to be understood that the vehicle 12 will collect the stationary object information for the amount of time defined in the user's participation agreement. For instance, if the user signs up for six months, the telematics unit 14 may be programmed to collect the stationary object information until the expiration of six months, or until being reconfigured to cease collecting the information. When the six month duration is about to elapse (e.g., two weeks before the expiration, or at some other predefined period), for example, the call/data center 24 may ask the user if he/she would be willing to continue to participate in the program for another length of time.

Referring now to the example depicted in FIG. 2 alone, once the user has agreed to participate in the stationary object detection program (or if the user is automatically participating because he/she is a subscriber), the method involves detecting a stationary object along a road segment (shown by reference numeral 200). Detection may be accomplished when the vehicle 12 is moving (e.g., while traveling along a road segment) or when the vehicle 12 is stopped (e.g., when stopped at a stop sign, stop light, etc.). While the participating vehicle 12 travels along a road segment (or when stopped), the object detection sensor(s) 88 surveys the road segment and areas surrounding the road segment for the presence of any objects that appear to be stationary. It is to be understood that any object that appears to be stationary may be detected by the sensor(s) 88. These objects include i) objects that are intended to remain stationary (e.g., street signs, lamp posts, telephone poles, or other objects that are intended to remain in a single location for a predefined length of time), and ii) objects that are momentarily stationary but are actually intended to move (e.g., parked cars, bicycles, or other objects that can move or be moved at the will of another).

In an example, the detection sensor(s) 88 substantially continuously surveys (i.e., with no or very insignificant interruptions) the road segment while the vehicle 12 is traveling. The sensor(s) 88 may otherwise survey the road segment during predefined intervals or in pulses. In instances where predefined intervals are used, the intervals may be defined based on time (e.g., every second, 10 seconds, 30 seconds, 1 minute, etc.), based on distance (e.g., every 100 yards the vehicle traveled, every half mile the vehicle traveled, every mile the vehicle traveled, etc.), or based on a trigger, such as when the vehicle 12 reaches a particular speed, when the vehicle 12 begins to decelerate, and/or the like.

The sensor(s) 88 may also be configured to detect more than one object at a time. For instance, upon approaching a stop light, the sensor(s) 88 may be able to detect a “No Turn on Red” sign, a pedestrian crosswalk light, a trash barrel, a newspaper stand, a mailbox, and the stop light itself In cases where the vehicle 12 includes a single sensor 88, the single sensor 88 is configured to detect each of the objects, typically in sequential order (e.g., in the order that the objects are actually detected by the sensor 88), and transmits a signal for each detected object to the processor 36 of the telematics unit 14 indicating the presence of the objects. In the foregoing example, the sensor 88 would send six signals, one for the “No Turn on Red” sign, one for the pedestrian crosswalk light, one for the trash barrel, one for the newspaper stand, one for the mailbox, and one for the stop light. In this case, the single sensor 88 would be able to recognize (and distinguish between) the six different objects base, at least in part, on six different detected patterns. These patterns would indicate the presence of the six different objects. In this non-limiting example, the detection of the stationary objects is a pattern matching exercise. In cases where the vehicle 12 includes a plurality of sensors 88, each of the sensors 88 may participate in detecting a single object (if only one is detected) or several objects (such as, e.g., the six objects of the example described above). In these cases, the sensors 88 may be individually designated to detect a particular type of object (e.g., street signs, trash barrels, etc.) or to detect an object (regardless of its type) in a particular location relative to the vehicle 12 (e.g., the right side of the vehicle, above the vehicle, etc.).

Upon detecting the object(s), the sensor(s) 88 transmit the signal(s) to the processor 36 (e.g., via the bus 34) indicating the presence of the object(s). In instances where the vehicle 12 is stopped (e.g., at a stop light), upon receiving the signal(s), the processor 36 queries the location detection unit 44 for GPS coordinate data of the then-current location of the vehicle 12. Since the vehicle 12 is stopped, the location of the vehicle 12 is approximately the same as the location of the detected object(s). In instances where the vehicle 12 is moving when detecting the stationary object, the location detection unit 44 may be configured to automatically submit the then-current GPS coordinate data to the processor 36 as soon as the object(s) are detected. This may be accomplished by linking the location detection unit 44 with the sensor(s) 88 so that the location detection unit 44 is ready to respond as soon as a signal is produced by the sensor(s) 88. The processor 36 may otherwise be configured to retrieve the GPS coordinate information from the location unit 44 as soon as a signal is received from the sensor(s) 88.

In an example, the sensor(s) 88 may also be configured to send additional data to the processor 36 upon detecting the object. The additional data may include, for example, information pertaining to the detected object such as, e.g., an estimated geometry of the object, the distance the object is from the vehicle 12 when detected, a heading for which the object is applicable (e.g., vehicle heading in all directions, vehicles heading in a particular direction only (e.g., north, south, etc.), the reflectivity of the object, and/or the like. This additional data may be utilized, by the processor 36 running appropriate software programs, for i) determining whether or not the detected object is actually stationary (as opposed to being non-stationary) (see reference numeral 201), and ii) determining whether or not the object is included in the sub-database stored in the memory 38 associated with the telematics unit 14 (see reference numeral 202). The processor 36 may determine that a detected object is stationary by determining the speed of the detected object. This may be accomplished using waves, such as ultrasound waves. For instance, when a wave is bounced off of a moving object, the speed of the object causes the returning wave to shift in frequency. For example, a wave that bounces off of an object that is traveling away from the sender/receiver typically appears to be longer (thus having a lower frequency) than a wave that bounces off of a stationary object. Correlatively, a wave that bounces off of an object that is traveling toward the sender/receiver typically appears to be shorter (thus having a higher frequency). Accordingly, by measuring the frequency of the return signal, the speed of the object may be derived. In instances where some of the return signal is based on non-moving background (e.g., the ground upon which the stationary object is sitting/standing), a Fast Fourier Transform can be applied to locate sidebands around the main signal frequency.

The processor 36 may otherwise determine that a detected object is stationary by deducing its speed via a digital radar. In this case, the radar measures the time it takes for a signal to bounce back from an object, and compares it to the time it takes a second signal to bounce back. If the time gets longer, the radar determines that the object is moving away. However, if the time gets shorter, the radar determines that the object is moving closer. It is to be understood that the time it takes for the signals to return can also be used to determine the distance to the object.

The processor 36 may also determine that a detected object is stationary, for example, by comparing the detected geometry of the object with geometries stored in a list of known stationary objects included in the sub-database stored in the memory 38. For instance, if the detected object has the geometry of a cylinder having an open end near the top of the object, the processor 36 may deduce (upon comparing the geometry with the geometries of known stationary objects in the stored list) that the detected object is most likely a trash barrel. However, if the geometry of a detected object does not match any of the known stationary objects included in the database and has a geometry that resembles, for example, a vehicle or a human being, then the processor 36 may deduce that the object is most likely non-stationary. In instances where the processor 36 determines that the object is non-stationary, the additional data is disposed of and the method starts over again at step 200.

On the other hand, when the processor 36 determines that the object is stationary, the processor 36 next determines whether or not the detected object is present in the database stored on-board the vehicle 12. This may initially be accomplished, for example, by reviewing the database for any objects located in substantially the same geographic location as the detected object (whose location is determined from the vehicle GPS coordinate data).

If a single object is present in the database having the same GPS coordinate data, the processor 36 may initially determine that the two objects (i.e., the object in the database and the detected object) could be the same. The processor 36 may then compare the geometry of the detected object (which was included in the additional data from the sensor(s) 88) with the single object present in the sub-database to verify the processor's 36 determination. If the geometries match, verification is made and the processor 36 concludes that the detected object is already included in the sub-database, and thus the detected object is also already included in the central database at the call/data center 24. Such conclusion may be based, at least in part, on the fact that the sub-database on-board the vehicle 12 was originally derived from the central database, and if the sub-database includes the object then the central database would include the object as well. In this situation, the processor 36 determines that sub-database (and thus the central database) does not have to be updated, and the method starts over at step 200 for a new detected object. Instances in which the geometries of the detected object and the one object present in the sub-database do not match are discussed further herein in reference to steps 204 et seq. Briefly, the non-matching geometries indicate that the detected object should be added to the sub-database.

If a number of objects are present in the sub-database having the same GPS coordinate data as the detected object, the processor 36 may select one of the objects in the sub-database as being a potential match. This determination would be based, at least in part, on whether the selected object has the same geometry as the detected object. The sensor information may provide an estimation of the object's geometry, and the processor 36 can compare the estimated geometry with the geometries of known objects at that GPS location. For example, if the processor 36 recognizes the geometry of the detected object as including an octagonal shaped head attached to a long rectangular post, the comparison with the list may reveal that the object is likely the stop sign at that particular corner. In instances where more than one of the objects in the sub-database have the same geometry (e.g., both a “No Turn on Red” sign and a speed limit sign have a rectangular shape and are located at the same geographic location), the processor 36 may query the sensor(s) 88 to provide additional data pertaining to the detected object so that the processor 36 can better deduce which object (if either) was actually detected. For instance, the sensor(s) 88 may provide information related to the color of the sign or to the writing displayed on the sign, and such information may be used by the processor 36 to deduce which object in the database was actually detected. In cases where the sensor(s) 88 cannot provide the additional data, or the additional data does not contribute to the processor's 36 determination, the processor 36 may assume that the detected object is not included in the sub-database, and that the sub-database should be updated.

In cases where no object having the same GPS coordinate data as the detected object is present in the database, the processor 36 may automatically conclude that the detected object is new, and that the sub-database should be updated.

When the processor 36 determines that the sub-database on-board the vehicle 12 should be updated, the processor 36 transmits a signal to the imaging device 86 (via the bus 34) including an instruction to take an image of the detected object (as shown by reference numeral 204), and the image may, in an example, be automatically sent to the call/data center 24 during a vehicle data upload (VDU) event (as shown by reference numeral 206). In an example, in response to the instruction from the processor 36, the imaging device 86 queries the sensor(s) 88 for the proximate location of the object relative to the vehicle 12. Upon receiving this information, the imaging device 86 rotates (if the device 86 is a rotating camera, for example) or is otherwise moved so that the device 86 faces the object and can capture an image. In instances where a plurality of imaging devices are used, the processor 36 may query the sensor(s) 88 for the proximate location of the object, and then transmit the instruction signal to one or more of the imaging devices 86 that are the closest to the object or have the best opportunity to take the image. It is to be understood that all of the process steps of this example method may be accomplished within a very small time frame (e.g., a second or two) so that the processor 36 may deduce whether or not a detected object is missing from the database on-board the vehicle 12 and to capture an image of the detected object before the vehicle 12 drives past it. This enables the example method to be accomplished when the vehicle 12 is traveling at high speeds such as, e.g., at 70 mph.

The image, the GPS coordinate data and possibly the additional data from the sensor(s) 88 are sent from the vehicle 12 (e.g., via the telematics unit 14) to the to the call/data center 24 upon determining that the sub-database should be updated. In some cases, the image, GPS coordinate data, and the additional data is sent separately, e.g., as packet data from the telematics unit 14 to the call/data center 24. In other cases, the GPS coordinate data and the additional data is embedded in the image, and only the image is sent to the call/data center 24.

In an example, the image, GPS coordinate data, and possibly the additional data is automatically sent to the call/data center 24 upon determining that the sub-database on-board the vehicle 12 needs updating. In another example, the image taken by the imaging device 86 (as well as other information pertaining to the object such as the GPS coordinate data and/or the additional data obtained by the sensor(s) 88) may be temporarily stored in the memory 38 of the telematics unit 14 until the call/data center 24 submits a request for the information. This request may be periodically made, for instance, by the call/data center 24, for example, when the call/data center 24 is ready to update its central database or in response to a request from the municipality for updating the municipal database. Upon receiving the request, the vehicle 12 (via a communications device such as the telematics unit 14) forwards the image, the GPS coordinate data of the detected object and possibly the additional data (e.g., direction of vehicle travel, etc.) obtained by the sensor(s) 88 to the call/data center 24, where such information is processed by the processor 84.

Upon receiving the image from the vehicle 12, the processor 84 executes suitable computer software programs for extracting information pertaining to the object from the image (as shown by reference numeral 208). This information may include, for example, the geometry of the object, the color of the object, any writing disposed on or associated with the object (e.g., the word “YIELD” printed on a yield sign), reflectivity of the object, and/or the like. The extracted information (as well as the coordinate GPS data of the object) may then be used by the processor 84 to determine the exact object that was detected, and whether or not the detected object is included in the central database stored at the call/data center 24 (as shown by reference numeral 210).

Determining whether or not the information extracted from the image is stored in the central database may be accomplished, by the processor 84, by comparing the extracted information (which may include any information that physically identifies the detected object (e.g., its geometry, color, heading direction, etc.) and the GPS coordinates of the detected object) with the objects present in the central database. The processor 84 may deduce that the central database includes the detected object if a match results. In such instances, the central database is not outdated. Likewise, the processor 84 may deduce that the central database does not include the detected object if a match does not result. In such instances, the central database is outdated. If this occurs, then the processor 84 executes suitable software programs for storing the detected object in the central database (shown by reference numeral 212).

The processor 84 updates the central database at the call/data center 24 by classifying the detected object, and then storing information related to the detected object (e.g., its type, location, heading, etc.) in an appropriate category of the central database (see reference numeral 212). The processor 84 uses the extracted image information to classify the object. Information pertaining to the object may then be stored in a specific category of the central database based on its classification. This may advantageously contribute to the organization of the central database. For example, if the processor 84 determines that the detected object is a street sign, the information related to the object may be saved in a category for street signs. In another example, if the processor 84 determines that the detected object is located within a particular telematics service region, then the information may be saved in a category including all of the objects then-currently located in that particular telematics service region. It is to be understood that the object information may also be saved in multiple categories so that correct information will be retrieved when creating a location circle for a vehicle 12. For example, when generating a new location circle, the processor 84 may access the street signs category as well as the telematics service region category in order to obtain the most comprehensive information set for the location circle.

Furthermore, a new sub-database may be generated from the updated central database (see reference numeral 216). In one example, the new sub-database is a subset of the central database including pre-existing information and the extracted information related to the newly detected stationary object. In another example, the new sub-database is simply an update including the extracted information related to the newly detected stationary object. Parameters for determining the type of new sub-database to generate may include geographic information of the vehicle 12, the amount of newly acquired information in the central database, the timing of the last update sent to the vehicle 12, or combinations thereof, or the like. In the following two examples, the sub-database is generated for the specific vehicle 12 from which the detected object information was obtained, and thus the new sub-database may include any new data for the geographic region that the vehicle 12 is then-currently located in. In the first example, the central database may re-evaluate the vehicle's geographic location and determine that a plurality of new object information (e.g., multiple construction barrels and signs in addition to detected object) has been recently added to the central database since the vehicle's last sub-database download. In this example, the central database may create a new sub-database which includes all of the information (i.e., old information, recently added information, and brand new information) within the vehicle's then-current location circle. When sending this sub-database to the telematics unit 14, the processor 84 may include instructions to replace the previously stored sub-database with the newly sent sub-database. In another example, the central database may recognize that the information that has been added to the central database since the timestamp associated with the most recently transmitted sub-database or update to the vehicle 12 includes the detected object alone. In this particular example, it is more effective to transmit a single update as the new sub-database. The updated information alone is sent, and is used to update the sub-database already stored in the memory 38 associated with the telematics unit 14 (as shown by reference numeral 214). In this example, the call/data center 24 may send instructions for storing the information in the already-existing sub-database on-board the vehicle 12. These instructions may include how and where to store the information in the sub-database. If the information of the detected object has been temporarily stored in the memory 38, the call/data center 24 instructions may prompt the telematics unit 14 to permanently store the information in the sub-database already resident in the memory 38.

In any of the examples disclosed herein, the sending of the new sub-database (whether a replacement sub-database or an update to an existing sub-database) is accomplished automatically upon generating the sub-database, periodically according to a predetermined time set or other trigger, in response to a request for the new sub-database from the vehicle 12, each time the central database is updated (e.g., when a new sub-database is generated based on information obtained from another subscriber vehicle 12), or combinations thereof.

In instances where the processor 84 determines that the detected object is present in the central database, the processor 84 may conclude that the central database is up-to-date. In some cases, the processor 84 may also be configured to notify the telematics unit 14 (by means, e.g., of a packet data message or the like) that the object is not new, and to recheck the sub-database on-board the vehicle 12 (see reference numeral 217). In this example, the processor 84 may transmit the information extracted from the image to the telematics unit 14 for comparison with the database currently stored therein. For example, the processor 84 may transmit information including the geometry, the heading direction, the words on the sign, the color of the sign, etc., and the telematics unit processor 36 may cross check the received information with its database. If the telematics unit 14 (via the processor 36) determines that the object is not missing from the sub-database on-board the vehicle 12, the telematics unit 14 may end the communication with the data center 24 (see reference numeral 221). However, if the telematics unit 14 (via the processor 36) determines that the object is still missing from the sub-database on-board the vehicle 12, the telematics unit 14 may request that the call/data center 24 send an updated sub-database to the vehicle 12, where such updated sub-database includes at least the detected object as an update to the existing sub-database (see reference numeral 223). The call/data center 24 may generate the new, updated sub-database (if one does not already exist), and send the updated sub-database to the vehicle 12 (as shown by reference numeral 225).

In still another example, the call/data center 24 may also send the new, updated sub-database to another entity, such as a municipality (shown by reference numeral 218). This transmission may occur automatically by the call/data center 24 in accordance with the contract agreement between the telematics service provider and the municipality, or may occur in response to a request from the municipality. In one example, an application protocol interface (API) may be available to the municipality so that the municipal database may automatically be updated each time the central database is updated. In any event, the updated sub-database may be used, e.g., by a processor associated with the municipality to update the municipal database.

In instances where the vehicle 12 that detected the stationary object is one of a plurality of subscriber vehicles 12 participating in the detection program, upon updating the central database, the call/data center 24 may transmit (automatically, periodically, in response to a request, or in response to a trigger) the updated sub-database (or subset of the central database) to at least some of the subscriber vehicles. As an example, if the detected stationary object is located in a particular geographic region, the call/data center 24 may transmit the updated sub-database to all of the subscriber vehicles that are then-currently located within that geographic region. In this example, the call/data center 24 may determine the then-current location of the subscriber vehicles by querying their respective telematics units for GPS coordinate data. The then-current location may otherwise be determined by reviewing the user profiles of the respective owners of the subscriber vehicles, and determining the vehicles that are located in the particular geographic region based on the garage addresses of the owners.

While not shown in FIG. 2, it is to be understood that the detected object may also be used to delete previously present data in the central database. It is to be understood, however, that authorization to delete the information is first obtained prior to the actual deleting. For example, if a vehicle 12 sends an image illustrating a yield sign on the northeast corner of an intersection, and the central database identifies a stop sign at the same corner, the information about the stop sign may be deleted and the information about the yield sign added. A similar example is when a traffic light has been added to an intersection that was previously a four-way stop sign intersection.

Another example of the method disclosed herein will now be described in conjunction with FIGS. 3 and 4. More specifically, this example includes all of the steps described above in conjunction with FIG. 2, but for updating a sub-database corresponding to a location circle within which the subscriber vehicle 12 (that detects the stationary object) is then-currently located.

Referring to FIGS. 3 and 4 together, an example of a method for determining a location circle within which the vehicle 12 is then-currently located includes generating a first location circle (as shown by reference numeral 300). As used herein, the term “first location circle” refers to a location circle surrounding the vehicle 12 that is initially created by the call/data center 24. In an example, the first location circle may be generated, via software programs run by the processor 84 at the call/data center 24, by forming a circle around, e.g., the garage address of the vehicle 12 owner (which location would be considered to be the center point CP1 of the circle), and a circle is drawn around the garage address having a predetermined radius (e.g., 30 miles, 100 miles, 200 miles, etc.). It is to be understood that the initial or first location circle will not necessarily be calculated using the garage address, but may be any GPS coordinates associated with the vehicle 12 upon an ignition on event. For example, the center point of the first location circle C1 may be determined from other points of interest such as, e.g., a business address of the vehicle 12 owner, or another location identified when the vehicle is turned on. An example of the first location circle is shown in FIG. 4 and is labeled “C1”.

Once the first location circle C1 is generated, the processor 84 creates a sub-database D1 for the first location circle. This sub-database D1, which is created from the central database at the call/data center 24, includes all of the known stationary objects that are located (at the time of creating the sub-database DO within the first location circle. The call/data center 24 thereafter sends the sub-database D1 to the vehicle 12, where it is stored in the electronic memory 38.

While the vehicle 12 is operating (i.e., is in a moving state), the processor 36 substantially continuously checks that the vehicle 12 is still located within the first location circle (as shown by reference numeral 301). So long as the vehicle 12 remains within this first location circle (C1 in FIG. 4), any stationary objects detected along the road segment(s) 400 traveled upon by the vehicle 12 are compared with the sub-database D1 corresponding to the first location circle C1 stored in the memory 38 to determine if the sub-database D1 needs to be updated (shown by reference numeral 306).

As the location of the vehicle 12 is continuously monitored, when the vehicle 12 travels outside of the first location circle C1 (as recognized, e.g., by the processor 36 via suitable software programs), the telematics unit 14 automatically initiates a connection with the call/data center 24 and requests an updated location circle and sub-database (as shown by reference numeral 302). In addition to the request, the telematics unit 14 also sends then-current location data of the vehicle 12 to the call/data center 24, and such location data is used to generate a new location circle (e.g., C2 shown in FIG. 4) around the vehicle 12. The new location circle C2 may, for example, have the same size (i.e., has the same radius) as C1, but with a different center point. The center point is the then-current location of the vehicle 12 as soon as the processor 36 detects that the vehicle 12 traveled outside of the first location circle C1. This new center point also corresponds with a point on the peripheral edge of the first location circle C1 (identified by CP2). When the new location circle C2 is drawn, this circle overlaps the first location circle C1 as shown in FIG. 4.

It is to be understood, however, that the new location circle C2 may be larger or smaller than the first location circle C1. For example, when the vehicle 12 is located in a rural area that may not include many stationary objects, the circles C1, C2 may be larger than circles C1, C2 generated when the vehicle 12 is in an urban area, where several stationary objects are typically present. In another example, if the vehicle 12 travels into a geographic area that has recently been mapped, less timely detection information is generally needed to update the central database, and thus larger location circles C1, C2 may be sufficient. As soon as C2 is generated, the processor 84 generates a new sub-database D2 from the central database, where the new sub-database D2 corresponds to the new location circle C2. The call/data center 24 then sends the new sub-database D2 to the vehicle 12 (as shown by reference numeral 304 in FIG. 3), which is stored in the memory 38. The storing of the new sub-database D2 may include, e.g., replacing the old sub-database D1 with the new one (i.e., the old sub-database is removed). In some cases, the new sub-database D2 may be stored in addition to the old one (i.e., the memory 38 includes both of the sub-databases D1, D2). This latter example may be desirable when the initial location circle and sub-database C1, D1 correspond with the user's garage address and are frequently used by the telematics unit 14.

It is to be understood that, in this example, the location circle C1, C2 is updated each time the vehicle 12 travels outside of a then-current location circle. For instance, if the vehicle 12 continues to travel along the road segment 400 and outside of C2, yet another new location circle (e.g., C3 (not shown in FIG. 4)) and a corresponding sub-database (e.g., D3 (also not shown in FIG. 4)) may be generated. Upon detecting a stationary object (e.g., the street sign 402 shown in FIG. 4), the steps of the method of FIG. 2 may be performed for updating the sub-database then-currently on-board the vehicle 12 (and ultimately the central database at the call/data center 24) (as shown by reference numeral 306).

The location circle may otherwise be updated based on a predefined point of interest. For instance, the call/data center 24 may deduce from, e.g., the user profile that the vehicle 12 is typically driven to and from the vehicle 12 owner's workplace. The processor 84 may therefore generate the first location circle C1 having the owner's garage address as the center point, and a second location circle C2 having the owner's business address as the center point. In this case, the two location circles may or may not overlap, which depends, at least in part, on how far apart the garage address is from the business address and what the radius of the circle is. A sub-database D1, D2 corresponding to each of the circles C1, C2 would be generated by the processor 84, sent to the vehicle 12, and stored in the memory 38. It is to be understood that, in this example, both of the databases D1, D2 may be generated and stored in the memory 38 prior to the vehicle 12 being operated, and such databases D1, D2 may respectively be updated when the vehicle 12 is traveling in the corresponding location circle C1 or C2 as objects are detected that do not appear in the appropriate sub-database D1, D2.

In yet another example not shown in the drawings, the method may include multiple first location circles C1, where each first location circle may be designated for different sub-databases based on classification. For instance, one of the first location circles may be designated for rest area signs, while another first location circle may be designated for stop signs. In this case, the first location circle for the rest area signs may be larger than that for the stop signs due, at least in part, to the fact that rest area signs may be sparse in geographic terms relative to stop signs. In instances where the sub-database is based on construction signs, e.g., the first location circle may be smaller due, at least in part, to the fact that such objects are temporary and frequent updates to the database for construction signs often occurs and/or is desirable.

In still another example not shown in the drawings, vehicle operators may call an application specific call center and report a stationary object at a particular location. The advisor 62, 62′ may enter the GPS location associated with the call, and may enter the stationary object information provided by the caller. This information may be sent to the data center 24 to cross check and potentially update the central database.

Any of the examples described above may be used to update a database with stationary objects that appear to be missing. It is to be understood that these examples may also be used to update a database with stationary objects that appear to be damaged or destroyed. For instance, the detection sensor(s) 88 may be configured to detect graffiti printed on a road sign, a light pole that is bent, a waste barrel that is dented, a bus stop bench with a broken leg, or the like. Accordingly, the central database (and ultimately the municipal database and/or the sub-database on-board the vehicle 12) is/are updated with a description of the then-current state of the detected object. In some cases, the description of the state of the object may be used, e.g., by the municipality for dispatching work crews to replace and/or repair the damaged objects.

While several examples have been described in detail, it will be apparent to those skilled in the art that the disclosed examples may be modified. Therefore, the foregoing description is to be considered exemplary rather than limiting.

1. A method for updating a database, comprising:
via a processor operatively associated with a vehicle, determining a location circle within which the vehicle is then-currently located;
obtaining, from a facility, a database corresponding to the location circle within which the vehicle is then-currently located;
detecting a stationary object along a road segment that is located in the location circle within which the vehicle is then-currently located, the detecting being accomplished using a sensor selectively and operatively disposed in the vehicle;
determining, via the processor associated with the vehicle, that the detected stationary object is missing from the database corresponding to the location circle within which the vehicle is then-currently located;
via a communications device disposed in the vehicle, transmitting an image of the stationary object to the facility; and
via a processor at the facility, updating the database corresponding to the location circle within which the vehicle is then-currently located with information related to the detected stationary object.

2. The method as defined in claim 1 wherein the updating of the database includes:
extracting the information related to the stationary object from the image via the processor at the facility;
determining, via the processor at the facility, if the information related to the stationary object extracted from the image is stored in a central database located at the facility; and
storing the information related to the stationary object in the central database if the processor determines that the information is missing from the central database.

3. The method as defined in claim 2 wherein prior to extracting the information related to the stationary object from the image, the method further comprises recognizing a geometry of the stationary object in the image.

4. The method as defined in claim 3 wherein prior to storing the information related to the stationary object in the central database, the method further comprises:
determining a type of the stationary object from its geometry recognized from the image; and
classifying the stationary object based on the type.

5. The method as defined in claim 2 wherein the storing of the information related to the stationary object includes storing the information in an appropriate sub-database based on the classifying.

6. The method as defined in claim 2 wherein after the updating of the database, the method further comprises transmitting a subset of the updated central database to the vehicle, the subset including the extracted information related to the stationary object stored therein.

7. The method as defined in claim 6 wherein the vehicle is one of a plurality of subscriber vehicles and the stationary object is established in a particular geographic region, and wherein the subset of the central database is automatically transmitted from the facility to one or more of the plurality of subscriber vehicles currently located or having a garage address in the particular geographic region, the automatic transmission of the subset of the central database occurring periodically, in response to a request for an updated database by the vehicle, each time the central database is updated, or combinations thereof.

8. The method as defined in claim 1 wherein prior to transmitting the image to the facility, the method further comprises storing the image in a memory operatively associated with the vehicle, and wherein the transmitting of the image to the facility occurs in response to a request for the image from the facility.

9. The method as defined in claim 1 wherein the determining of the location circle within which the vehicle is then-currently located includes:
recognizing, via the processor associated with the vehicle, that the vehicle is then-currently located outside of a first location circle; and
in response to the recognizing, via the communications device disposed in the vehicle, requesting the facility to determine a second location circle, the second location circle being the location circle within which the vehicle is then-currently located.

10. The method as defined in claim 9 wherein the obtaining of the database corresponding to the location circle within which the vehicle is then-currently located includes:
transmitting, from the facility to the communications device, a database corresponding to the second location circle; and
storing the database corresponding to the second location circle in an electronic memory associated with the communications device.

11. The method as defined in claim 10 wherein the storing of the database includes replacing the database corresponding to the first location circle with the database corresponding to the second location circle.

12. The method as defined in claim 1 wherein prior to transmitting the image of the stationary object to the facility, the method further comprises taking the image of the stationary object via at least one camera operatively connected to the vehicle.

13. A system for updating a database, comprising:
a vehicle, including:
a sensor configured to detect a stationary object along a road segment;
a processor operatively associated with the sensor, the processor including computer readable code for determining if the detected stationary object is stored in the database; and
a telematics unit operatively associated with the processor, the telematics unit having associated therewith a memory configured to store a database corresponding to a location circle within which the vehicle is then-currently located;
at least one imaging device disposed in or on the vehicle, the imaging device configured to take an image of the stationary object in response to a command by the processor if the processor determines that the detected stationary object is missing from the database corresponding to the location circle within which the vehicle is then-currently located; and
a facility in selective communication with the telematics unit and configured to receive the image from the telematics unit, the facility comprising:
a central database including a plurality of stationary objects stored therein; and
an other processor having computer readable code for updating the database corresponding to the location circle within which the vehicle is then-currently located with information related to the stationary object included in the image.

14. The system as defined in claim 13 wherein the stationary object is selected from a street sign, a construction sign, a landmark, or combinations thereof.

15. The system as defined in claim 13 wherein the computer readable code for updating the database with the information related to the stationary object included in the image includes:
computer readable code for extracting the stationary object from the image;
computer readable code for determining if the information extracted from the image is stored in a central database; and
computer readable code for storing the information related to the stationary object in the central database if it is determined that the information is missing from the central database.

16. The system as defined in claim 15 wherein the central database includes sub-databases based on a classification of the stationary object, and wherein the computer readable code for updating the database includes:
computer readable code for recognizing a geometry of the stationary object reflected in the image;
computer readable code for determining a type of the stationary object from its geometry recognized from the image; and
computer readable code for classifying the stationary object based on the type.

17. The system as defined in claim 13 wherein the other processor further has computer readable code for creating a new database corresponding to the location circle within which the vehicle is then-currently located, the new database being a subset of the central database.

18. The system as defined in claim 13 wherein the facility is a call center in selective and operative communication with a plurality of subscriber vehicles, and wherein the call center is configured to update a respective database for each of the plurality of subscriber vehicles.

19. The system as defined in claim 18 wherein the call center is in selective and operative communication with a municipal database, and wherein the call center if further configured to update the municipal database.

20. The system as defined in claim 13 wherein the vehicle further includes a location detection system configured to detect the location of the stationary object, and wherein the telematics unit is configured to transmit both the image and the location of the stationary object to the facility.
